(19) United States
(12) Patent Application Publication
(10) Pub. No.: US 2024/0327097 A1
(43) Pub. Date: Oct. 3, 2024

(54) Insulation System for Ground Mobile Robots Designed for Last-Mile Deliveries

(71) Applicants: Andres Felipe Chavez Cortes, El Cerrito, CA (US); Leonardo Andrés Correa Romero, Medellín (CO); Steven Alejandro Otálora Guerrero, Medellín (CO)

(72) Inventors: Andres Felipe Chavez Cortes, El Cerrito, CA (US); Leonardo Andrés Correa Romero, Medellín (CO); Steven Alejandro Otálora Guerrero, Medellín (CO)

(21) Appl. No.: 18/620,169

(22) Filed: Mar. 28, 2024

Related U.S. Application Data
(60) Provisional application No. 63/492,599, filed on Mar. 28, 2023.

(51) Int. Cl. B65D 81/38; B65D 25/10

(52) U.S. Cl. CPC B65D 81/3834; B65D 25/108

(57) ABSTRACT

An insulation system for a mobile delivery robot including a container and a thermal shield. The thermal shield is coupled to the bottom of the container to provide a thermal barrier between the contents of the container and the components of the mobile robot. The container further includes components to organize food products including drink holders and a plurality of supports for supporting food boxes, such as a pizza box.

### FIELD OF THE INVENTION

The present invention relates generally to insulation of items delivered by mobile robots designed for last-mile deliveries. More specifically, the present invention relates to an insulation system designed to preserve the temperature of food items delivered by mobile robots to customers.

### BACKGROUND OF THE INVENTION

Last-mile deliveries are a key part of the logistics industry. Delivery of goods has traditionally been done by a human courier mobilized by a manned vehicle. However, concerns regarding carbon emissions, increased traffic and rising labor cost have generated doubts from stakeholders on the long-term viability of conventional delivery methods.

In the last few years, automation efforts have been pushed to solve many of these issues, and unmanned systems have been proposed as the best alternative for this method. Both ground and aerial unmanned systems are being used for last-mile deliveries, but aerial systems have been largely excluded from this technological adoption due to security concerns and restrictive regulatory frameworks. This setting makes ground mobile robots the ideal solution for the delivery of items from businesses to customers.

Such robots are being released in small iterations which enable their use on sidewalks, preventing an increase in traffic. Furthermore, these mobile robots operate with electric batteries, thus helping drive down carbon emissions in the logistics industry. These systems may navigate autonomously and/or semi-autonomously with the help of a computer vision system based on the use of several sensors and sophisticated algorithms for analysis of the environment. Robots can leverage this technology to reach destinations within a radius surrounding the businesses providing the items to be delivered.

The most important segment for robotic last-mile deliveries is the food sector. This segment includes groceries and meals from restaurants, both areas where the temperature of the items being delivered is an important factor for customers. It is because of this reason that items should remain insulated during delivery, in order to guarantee that hot meals remain hot and certain groceries remain fresh.

The present invention provides a solution to this matter by implementing an insulation system for mobile robots designed for last-mile deliveries. This subsystem is enclosed within the cabin of the mobile robot, and includes the insulation bag, contained within a container element designed to retain the heat within the bag and prevent robotic electronic components from spreading heat into the bag where the items are stored.

### SUMMARY OF THE INVENTION

Given the developments highlighted beforehand, it is the object of the present invention to provide developers of ground-based robotic platforms with an insulated bag for last-mile deliveries of groceries and consumables. The present invention is specified in the claims as well as in the below description. Preferred embodiments are particularly specified in the dependent claims and the description of various embodiments.

### BRIEF DESCRIPTION OF THE DRAWINGS

FIG. 1 is an exploded perspective view of the present invention.

FIG. 2 is an exploded perspective view of the flange and the container of the present invention.

FIG. 3 is a top view of the present invention including a drink holder.

FIG. 4 is a perspective view of the container of the present invention.

FIG. 5 is a perspective view of the U-bracket of the present invention.

FIG. 6 is a top perspective view of the present invention.

FIG. 7 is a bottom perspective view of the present invention.

FIG. 8 is an additional top view of the present invention including a drink holder.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an insulation system for mobile delivery robots, embodiments of the present disclosure are not limited to use only in this context.

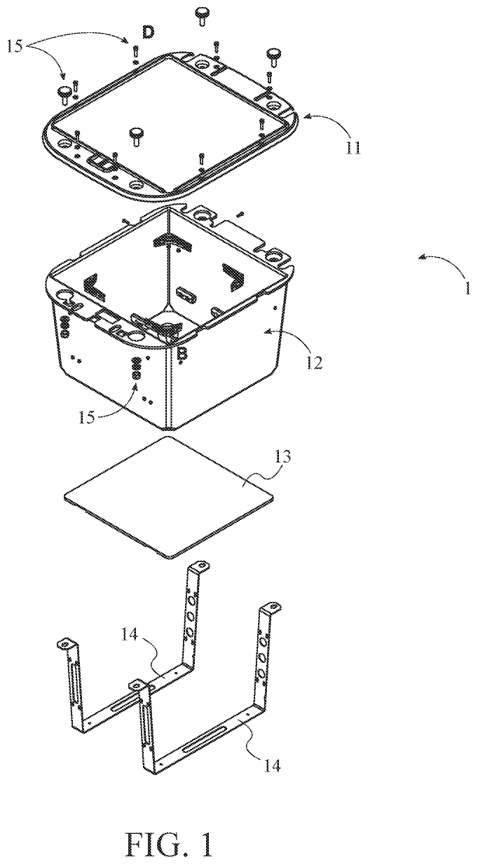

As shown in FIG. 1, the present invention is an insulation system for a mobile delivery robot 1 comprising a flange 11, a container 12, a thermal shield 13, and a plurality of U-brackets 14. As shown in FIG. 1, the flange 11 is coupled adjacent to the container 12; and the U-brackets 14 secure the thermal shield 13 to the container 12. In the preferred embodiment of the present invention, a plurality of fasteners 15 secures each of the aforementioned components 11, 12, 13, 14 rigidly together. Moreover, within the preferred embodiment of the present invention, the thermal shield 13 is composed of a polycarbonate material. In such an embodiment, it is essential for the thermal shield 13 to be composed of a high temperature resistant material in order to protect the adjacent components of the mobile robot, some of which being temperature sensitive electrical components.

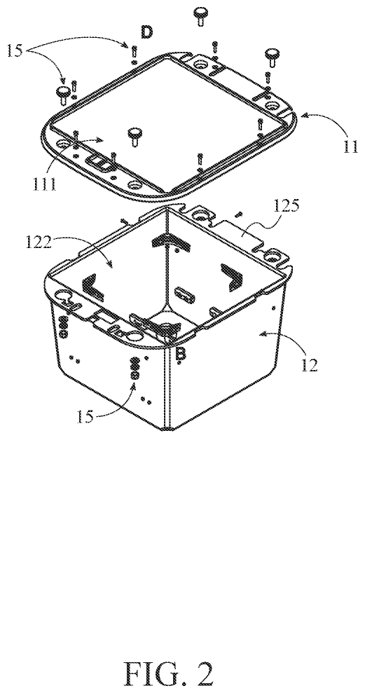

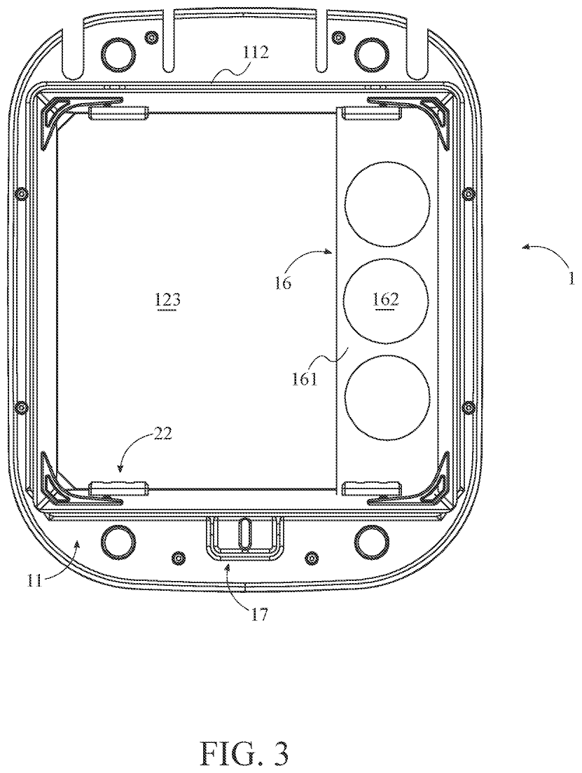

As shown in FIG. 2 and FIG. 3, the flange 11 of the present invention comprises an opening 111 and a lip 112. In the preferred embodiment of the present invention, the lip 112 is a ridge traversing the perimeter of the opening 111. Further, the flange 11 is coupled to the topmost portion of the container 12 wherein the opening 111 provides access to an internal cavity 122 of the container 12.

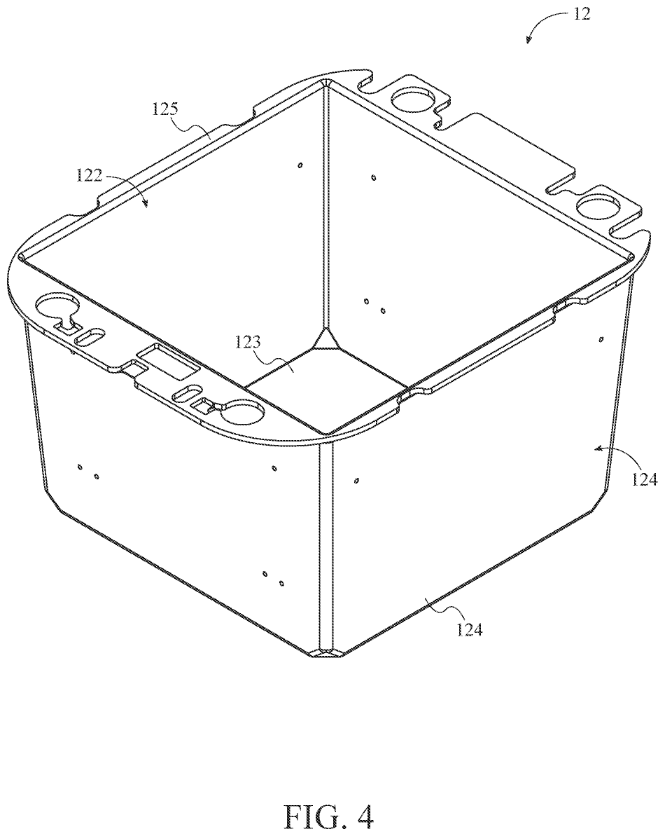

As shown in FIG. 4, within the preferred embodiment of the present invention, the container 12 comprises a plurality of sidewalls 121 and a base 123, thus composing an internal cavity 122. In the preferred embodiment of the present invention, the container 12 is composed of an ABS thermoformed plastic material. In such embodiments, the thermoformed material allows for faster and more efficient manufacturing than alternative methods. The base 123 composes the bottom most portion of the container 12, wherein the plurality of sidewalls 121, comprising four sidewalls in the preferred embodiment, traverse the perimeter of the base 123 wherein each of the walls traverses one side of the base 123. The container 12 of the present invention further comprises an exterior 124 wherein said exterior 124 is the outwardly facing surface of the container 12. Additionally, as shown in FIG. 4, the container 12 of the present invention further comprises a rim 125. In the context of the present invention, the flange 11 couples to the rim 125 of the container 12 and is secured in place via the plurality of fasteners 15.

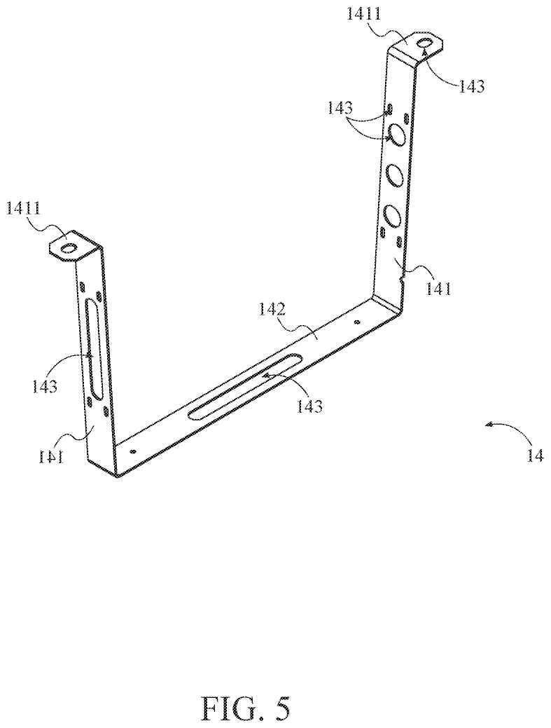

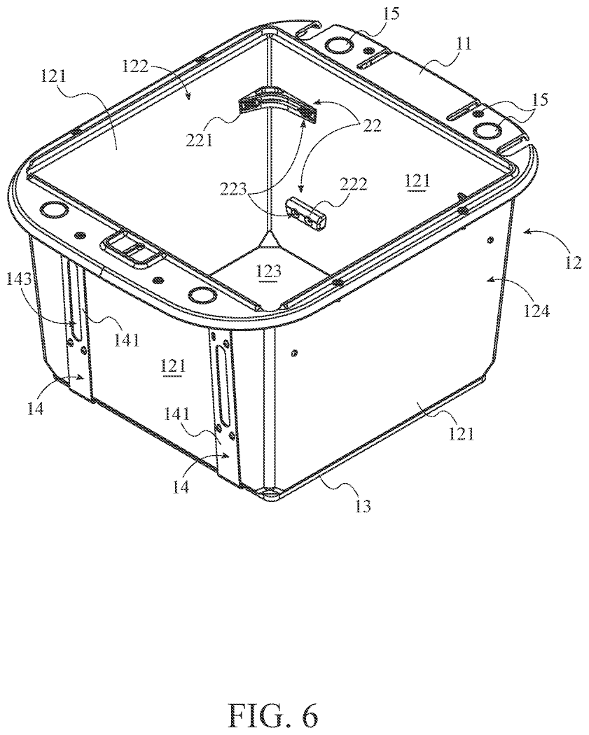

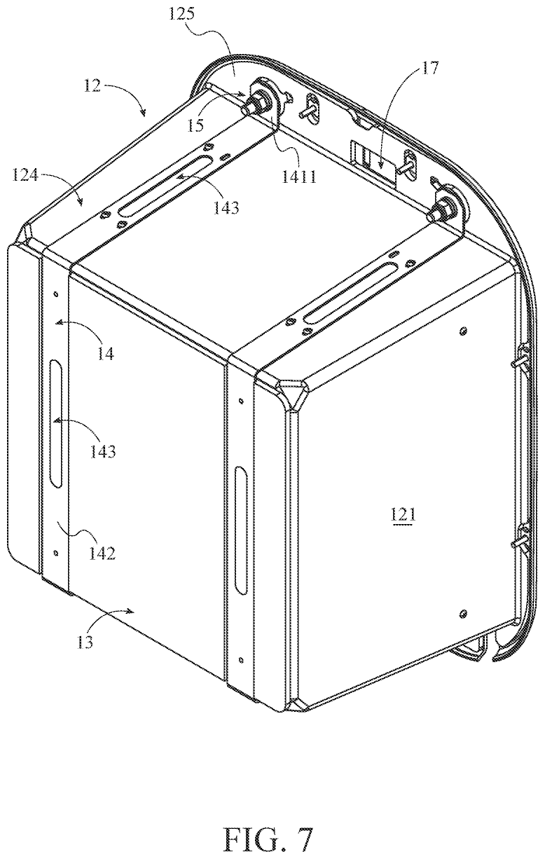

Referencing FIG. 5, the U-brackets 14 are U-shaped brackets composed of a plurality of vertical members 141 and a horizontal member 142. In the preferred embodiment, each of the vertical members 141 extend outwardly from opposing distal ends of the horizontal member 142. Furthermore, the U-brackets 14 further comprise a plurality of tabs 1411. In the preferred embodiment of the present invention, the plurality of tabs 1411 numbers two, wherein one tab extends horizontally outward from the distal end of each vertical member 141, opposite the end adjacent to the horizontal member 142. Furthermore, the U-brackets 14 further comprises a plurality of mounting slots 143. In the context of the present invention, the plurality of mounting slots 143 are used to secure the present invention to the mobile robot. Additionally, the plurality of mounting slots 143 may further be used couple the U-bracket 14 to the container 12, using the plurality of fasteners 15, as shown in FIG. 6 and FIG. 7. In the preferred embodiment of the present invention, the U-brackets 14 secure the thermal shield 13 to the container 12 whereby the thermal shield 13 is interposed between the horizontal member 142 of the U-brackets 14 and the base 123 of the container 12.

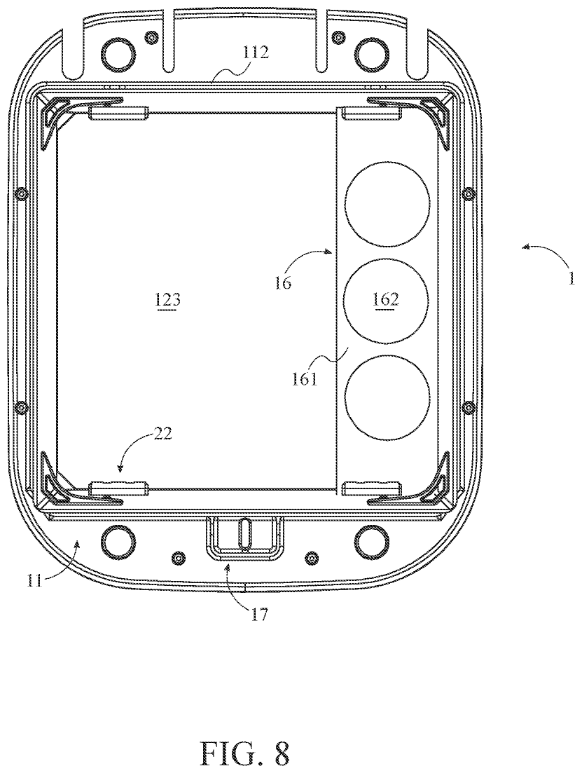

As shown in FIG. 6, in some embodiments of the present invention, the internal cavity 122 of the container 12 may further comprise a plurality of supports 22. The plurality of supports 22, comprising L-brackets 221 and horizontal supports 222, are coupled to the container 12 via a plurality of mounts 223. In the preferred embodiment of the present invention, the plurality of L-brackets 221 are positioned in each of the corners composed by adjacent sidewalls 121. In the context of the present invention, mounts 223 are fasteners that secure the plurality of supports 22 to the container 12. In some embodiments of the present invention, the mounts 223 may be secured through the container 12, thus threading into the U-brackets 14. In the preferred embodiment of the present invention, the plurality of supports 22 are designed to support food boxes, such as pizza boxes, within the container 12, whereby such boxes are not contacting the base 123 of the container 12. Furthermore, as shown in FIG. 8, the container 12 may further comprise an at least one drink holder 16 comprising a body 161 and an at least one drink cavity 162, wherein the drink cavity 162 is configured to position and maintain a beverage container in an upright position. In the preferred embodiment of the present invention, the position of the plurality of supports 22, in relation to the drink holder 16, is high enough to allow a beverage container to be held upright without interfering with the food box being supported by the plurality of supports 22.

Within the preferred embodiment of the present invention, as further shown in FIG. 7, the present invention further comprises a locking mechanism 17. In the context of the present invention, within some embodiments of the present invention, the insulation system 1 may comprise a lid wherein said lid will be sealed during delivery and secured via the locking mechanism 17 of the present invention. In some embodiments, the locking mechanism 17 may comprise a latching mechanism. In alternative embodiments of the present invention, the locking mechanism 17 may comprise a cavity wherein a user may insert a prefabricated locking system.

Although the invention has been explained in relation to its preferred embodiment, it is to be understood that many other possible modifications and variations can be made without departing from the spirit and scope of the invention.

What is claimed is:

1. An insulation system for mobile delivery robots comprising:
a container; and
a thermal shield;
wherein:
the thermal shield is coupled to the outwardly facing surface of the container;
the container is composed of a thermoformed acrylonitrile butadiene styrene plastic; and
the thermal shield is a polycarbonate panel.

2. The insulation system for mobile delivery robots, as claimed in claim 1, further comprising a plurality of U-brackets;
said U-brackets comprising:
a plurality of vertical members; and
a horizontal member;
the vertical members extending outwardly from opposing distal ends of the horizontal member;
the U-bracket coupling the thermal shield to the container whereby the thermal shield is interposed between the horizontal member of the U-brackets and the base of the container.

3. The insulation system for mobile delivery robots as claimed in claim 2, further comprising a plurality of fasteners wherein said fasteners couple the U-bracket to the container.

4. The insulation system for mobile delivery robots as claimed in claim 3, wherein the container comprises:
a plurality of sidewalls; and
a base;
the base composing the bottom-most portion of the container;
the plurality of sidewalls traversing the perimeter of the base; and
the thermal shield coupling to the base.

5. The insulation system for mobile delivery robots as claimed in claim 4 wherein the container further comprises an interior cavity and an exterior surface wherein:
the internal cavity is a volume formed by the base and the plurality of sidewalls;
the exterior surface is the outwardly facing surface of the container; and
the thermal shield and the plurality of U-brackets are coupled to the exterior surface of the container.

6. The insulation system for mobile delivery robots as claimed in claim 5, further comprising a plurality of supports wherein said supports are coupled to the plurality of sidewalls of the container, within the internal cavity.

7. The insulation system for mobile delivery robots as claimed in claim 6, wherein the plurality of supports comprise a plurality of L-brackets wherein said L-brackets are positioned in each of the corners composed by adjacent sidewalls.

8. The insulation system for mobile delivery robots as claimed in claim 6, wherein the plurality of supports are coupled to the container using a plurality of mounts.

9. The insulation system for mobile delivery robots as claimed in claim 6, further comprising a flange;
the flange comprising an opening; and
the flange being coupled to the topmost portion of the container whereby the opening provides access to the internal cavity of the container.

10. The insulation system for mobile delivery robots as claimed in claim 9 wherein the U-brackets further comprising a plurality of tabs; and
each of the plurality of tabs extending horizontally outward from distal ends of each of the vertical members.

11. The insulation system for mobile delivery robots as claimed in claim 10, further comprising a locking system.

12. The insulation system for mobile delivery robots as claimed in claim 10, further comprising a drink holder;
said drink holder being positioned within the internal cavity of the container; and
said drink holder comprising a body and an at least one drink cavity wherein said drink cavity is an extrusion within the body.

13. An insulation system for mobile delivery robots comprising:
a container;
a thermal shield; and
a plurality of U-brackets;
wherein:
the plurality of U-brackets coupling the thermal shield to the container whereby the thermal shield is interposed between a portion of the U-brackets and the container;
the container is composed of a thermoformed acrylonitrile butadiene styrene plastic;
the container further comprising a plurality of supports within an internal cavity of the container;
said plurality of supports being coupled to the container; and
the thermal shield is a polycarbonate panel.

14. The insulation system for mobile delivery robots as claimed in claim 13, further comprising a plurality of fasteners wherein said fasteners couple the U-bracket to the container.

15. The insulation system for mobile delivery robots as claimed in claim 14, wherein the container comprises:
a plurality of sidewalls; and
a base;
the base composing the bottom-most portion of the container;
the plurality of sidewalls traversing the perimeter of the base; and
the thermal shield being interposed between the U-brackets and the base of the container.

16. The insulation system for mobile delivery robots as claimed in claim 15, further comprising a flange;
the flange comprising an opening; and
the flange being coupled to the topmost portion of the container whereby the opening provides access to the internal cavity of the container.

17. The insulation system for mobile delivery robots as claimed in claim 16, further comprising a drink holder;
said drink holder being positioned within the internal cavity of the container; and
said drink holder comprising a body and an at least one drink cavity wherein said drink cavity is an extrusion within the body.

18. An insulation system for mobile delivery robots comprising:
a container;
a thermal shield; and
a drink holder;
wherein:
the thermal shield is coupled to the outwardly facing surface of the container;
said drink holder being positioned within an internal cavity of the container; and
said drink holder comprising a body and an at least one drink cavity wherein said drink cavity is an extrusion within the body;
the container is composed of a thermoformed acrylonitrile butadiene styrene plastic; and
the thermal shield is a polycarbonate panel.

19. The insulation system for mobile delivery robots, as claimed in claim 18, further comprising a plurality of U-brackets;
said U-brackets comprising:
a plurality of vertical members; and
a horizontal member;
the vertical members extending outwardly from opposing distal ends of the horizontal member;
the U-bracket coupling the thermal shield to the container whereby the thermal shield is interposed between the horizontal member of the U-brackets and the base of the container.

20. The insulation system for mobile delivery robots as claimed in claim 19, further comprising a plurality of fasteners wherein said fasteners couple the U-bracket to the container.
